(19) United States
(12) Patent Application Publication
(10) Pub. No.: US 2014/0155142 A1
(43) Pub. Date: Jun. 5, 2014

(54) SYSTEMS, METHODS, APPARATUS AND USER INTERFACES FOR GAMING AND WAGERING

(71) Applicants: Gregory John Conroy, Caulfield North (AU); Geoffrey McDowell, Mentone (AU)

(72) Inventors: Gregory John Conroy, Caulfield North (AU); Geoffrey McDowell, Mentone (AU)

(73) Assignee: BET SOLUTIONS PTY LTD, Scoresby, Victoria (AU)

(21) Appl. No.: 14/123,035

(22) PCT Filed: Nov. 22, 2011
(86) PCT No.: PCT/AU2011/001510

§ 371 Date: Feb. 18, 2014

(30) Foreign Application Priority Data
Jun. 1, 2011 (AU) 2011902184

(51) Int. Cl. G07F 17/32

(52) U.S. Cl. CPC G07F 17/3288
USPC 463/25

(57) ABSTRACT

The present invention provides systems, methods, apparatus and user interfaces for gaming and wagering for events, such as horse and greyhound racing, roulette and other events. According to some embodiments, the system comprises a receiver to receive first inputs relating to one or more events. The first inputs can include a stake, at least two selections in at least one of the events, such as two horses and at least one input relating to one or more bet types, such as a reward level. A determination device is connectable to the receiver to automatically determine wagers according to the first inputs. The determined wagers include a distribution of the stake between one or more bet types involving the at least two selections in proportion to a probability of bets making up the bet types yielding a return.

### FIELD OF THE INVENTION

The present invention relates to systems, methods, apparatus and user interfaces for gaming and wagering. In particular, the present invention relates to creating wagers and transacting wagers with a wagering operator. This invention relates to a participant making a wager on an event (or events), for example, but not limited to, horse racing (galloping, trotting, harness) and greyhound racing. However, the present invention is applicable to other types of events, games and gaming, such as roulette.

This invention can be applied most readily to totalisator betting. However, it is not limited to that type of betting and can be applied to practically any betting. In this document the examples will draw on totalisator betting common bet types and roulette because this invention is easy to understand within these frameworks.

### BACKGROUND

In undertaking a wager on an event such as horse racing there is provision to allocate the nominated selection or selections of a participant across a number of different betting types, for example, but not limited to (win, place, show, exacta, quinella, trifecta, first-four, quadrella and indeed, any other bet type that involves the selection of one or more runners in an event or events that has a dividend derived from or dependent upon the successful selection of that runner or runners).

Totalisator betting is well established around the world and in its simplest form involves the acceptance of wagers across an event, the deduction of a commission to the operator, and the distribution of the remaining pool of funds from those wagers to the participants that successfully selected the right selections based on the rules of the totalisator pool.

For example, if there was a totalisator WIN pool, then the object is to select the winner of the event. For an EXACTA pool, the object is to select the winner AND the second place getter in order. This concept can be extended to other totalisator bet types and their nominated rules of winning, such as TRIFECTA (1st, 2nd and 3rd in order), FIRST4 (1st, 2nd, 3rd, 4th in order), etc.

The bet types discussed above that are readily offered by totalisator companies across the world have particular features. However, the betting rules are not always easily understood by participants (e.g.: a Quinella and an Exacta bet both involve choosing the 1st and 2nd place getter in a race. However, the former does not require the selections in exact order and consequently is easier to win, while the latter requires the selections in exact order).

An “Exotic bet” option is throughout this document any bet type that involves something more than singularly selecting the winner or a place getter, i.e.: other than a WIN or PLACE bet type. These exotic bets usually result in haphazard staking because the number of permutations and the percentage chance of each permutation are not easily understood. A person placing an exotic bet that is an inexperienced bettor will tend to bet according to convenience rather than using rational mathematics. Exotic bet placement according to convenience usually results in bets being placed that are characterised by inefficient wagering.

E.g. a customer may wish to place a trifecta bet and has chosen four horses that they think have a good chance of filling all three places. Such a bet will usually be placed in either a ‘standout’ or ‘boxed’ fashion. A standout bet is when a number of selections are chosen to fill a particular place. A boxed bet is when all permutations or arrangements of selections that could make the set of three places are bet.

At present if a customer wishes to undertake standout and boxed betting for an example in which the customer thinks horses 5, 6, 10 and 11 have good chance of winning, the following standout and boxed bets can be made:

TABLE 1

A Standout Bet: 6 & 10 for 1st place
6 & 10 & 5 for 2nd place
6 & 10 & 5 & 11 for 3rd place
Combinations: 8
Total Cost for $1 unit = $8

TABLE 2

A Boxed Bet: 5 & 6 & 10 & 11 for 1st, 2nd, 3rd places
Combinations: 24
Total Cost for $1 unit = $24

For each of the examples, standout and boxed, the customer has wagered the same amount on each combination although the probability of each combination occurring based on the betting market (assuming each horse is not the same odds or price in the betting market) is not the same. This inherent inefficiency in bet placement into the totalisator pool is often taken advantage of by more sophisticated customers who bet each combination in a mathematically advantageous ratio. In effect, the standout and boxed bet taking customers (and even the single bet—or flat staking—customers) are providing profitable wagering scenarios to the sophisticated customers.

Similar problems and inefficiencies exist in gaming, such as roulette.

In summary, the existing systems provide a barrier to the inexperienced customer to maximise their return from their wagering and gaming investments and at the same time provide opportunity for more professional customers to profit from the inexperienced customers. Furthermore, potential customers may refrain from placing bets at all due to their lack of understanding of more complicated betting options.

### OBJECT OF THE INVENTION

It is a preferred object of this invention to address one or more of the issues of current wagering and/or gaming techniques or at least ameliorate at least one or more problems of the aforementioned current wagering and/or gaming techniques or provide a useful alternative to the aforementioned current wagering and gaming means.

### SUMMARY OF THE INVENTION

In one aspect, but not necessarily the broadest aspect, the invention resides in a wagering and/or gaming system for at least one event comprising:

a receiver to receive first inputs relating to at least one event, said first inputs including a stake, at least two selections in at least one event and at least one input relating to one or more bet types; and

a determination device connectable to the receiver to automatically determine wagers according to the first inputs;

wherein the determined wager includes a distribution of the stake between one or more bet types involving the at least two selections in proportion to a probability of bets making up the bet types yielding a return.

Suitably, the at least one input relating to one or more bet types is in the form of a reward level.

Suitably, the first inputs further include the selection of one or more event.

Suitably, the receiver receives at least one second input related to one or more style criteria relevant to selection or creation of wagers to be transacted.

Suitably, the receiver is in the form of a telecommunication access device for receiving the first and optionally one or more of the second inputs from a user over a communications network.

Alternatively, the receiver is in the form of an area on a gaming table, such as a roulette table, for receiving the first inputs and optionally one or more of the second inputs from the user.

Suitably, the determination device automatically determines wagers according to both the first and second inputs.

Suitably, the determination device is connectable to a market providing a market communication comprising wagers and returns on wagers to determine reward values on determined wagers.

Suitably, the determination device selects the appropriate transacting wagers in accordance with the first and second inputs and the market communication.

Suitably, the system comprises an output device connectable to the determination device to output the selected or created wagers to be transacted.

The system subsequently allows users to transact wagers that best suit the users for transmission to a betting organiser on the market.

Suitably, the one or more style criteria relevant to the selection and/or creation of wagers to be transacted can include: maximise a reward value; maximise a chance of a reward value; take a particular level of a conservative or a risky approach or the like.

Suitably, the determination device includes one or more of the following for the determination of wagers: an event control module; a bet acceptance module; a bet creation module; a dividend declaration module.

Suitably, at least one of the first inputs and/or at least one of the second inputs is set by default or is selected by a user.

The stake may be specified by a user, selected from one of a plurality of predetermined amounts, be variable by a user after selection and/or have a minimum amount for the event.

Suitably, an option for a selection in the event includes one or more of the following: a “market mover”; “other tipsters selections”; “the most other favoured selections in the market”; “weighted random selections”.

Suitably, the reward level comprises one or more of the following: a colour code according to a possible return value; a label according to a possible return value; a possible maximum win value; a possible minimum return value; an estimated possible return value; a range of possible return values; a promotional element; one or more special return values or prizes associated with promotion of one of the events.

Suitably, one or more of the following may be variable by a user: the bet types constituting the reward level; the percentages of the stake distributed to the bet types of the reward level; a market price upon which a wager is based.

Suitably, a selection in the event can include a banker selection which must fill a position nominated in the bet type in an outcome of the event for the wager to be successful.

The system may further include the determination device generating a profitability warning when it is unlikely that a profit will be made from the wager.

Suitably, a user can provide the first and/or second inputs to the telecommunication access device via a computing device, such as a smart phone, laptop or desktop computer, tablet or the like.

Suitably, the first inputs can include a stake amount, such as $x, an event, such as race y at location z, and a bet type, such as a quinella. The second input can include a style criterion, such as maximise a reward value.

The determination device can automatically:

determine options for wagers according to the first and second inputs;

determine reward values for determined options; and

select the appropriate wagers in accordance with the first and second inputs.

The output device can provide an output of the selection or creation of wagers to be transacted that fulfils the requirements of the first and second inputs.

The transacting wagers can be a collection of different bet types. In horse racing for example, it can comprise win, place and exotics including quinellas, trifectas, quadrellas etc.

Preferably the determination and selection of options for wagers occurs close to the beginning of the event upon which the wager is being transacted in order to determine an expected final reward value and allow the most accurate placement of derived wagers.

In accordance with another aspect, but not necessarily the broadest aspect, the invention resides in a method of wagering and/or gaming for at least one event including the following steps:

a receiver receiving first inputs relating to at least one event, said first inputs including a stake, at least two selections in the event and at least one input relating to one or more bet types;

automatically determining wagers according to the first inputs in a determination device connectable to the receiver; and

determining a distribution of the stake between one or more bet types involving the at least two selections in proportion to a probability of bets making up the bet types yielding a return.

Suitably, the at least one input relating to one or more bet types is in the form of a reward level.

The method may include the receiver receiving at least one second input related to one or more style criteria relevant to the selection or creation of wagers to be transacted.

The method may include a market, connectable to the determination device, providing wagers and returns on wagers to determine reward values on determined wagers.

The method may include the determination device automatically determining wagers according to the first and second inputs and communications from the market.

The method may include outputting selected or created wagers to be transacted to an output device and/or to a betting organiser connectable to the determination device.

The method may include providing an input device for a participant to enter the first inputs and optionally the second inputs.

The method may include the determination device automatically determining an optimal allocation of the selections in the event over one or more wagers to maximise a return in the event that one or more of the selections receives a favourable result in the event that results in a return for the wager.

Suitably, the method includes the determination device automatically determining an optimal allocation by:

assessing the options of wagering;

assessing the odds of return for the options of wagering;

assessing the reward level for the options of wagering; and

determining the optimal allocation dependent on the selected or default reward level.

The method may include the betting organiser of the wagering event receiving the wagers and:
a) accepting the total wagering stake;
b) validating the selections and reward level;
c) proportioning the total stake across a number of wagering investments dependent on the reward level; and
d) paying out dividends on any successful wagers.

Selecting a reward level other than the default reward level will have the impact of either increasing or decreasing the potential weighting of the individual bets across and/or within bet types that are created by the determination device so that the mathematical likelihood of the individual bets, their derived probability and ‘approximately calculated dividend’ deriving winning dividends is either higher or lower than the default level.

The method preferably includes validation of the inputs made by the participant by determining the bet types (or totalisator pools) operating on the default event or the event selected by the participant. There could be occasion for the pools to be connected to a particular event by way of definition or circumstance. For example, an event with only two contingencies (such as a horse race with only two runners) would, by circumstance that there are only two runners, be limited to only having associated totalisator pools that require selection of two or fewer runners, viz: win, place, exacta and quinella totalisator pools.

In another example, there may be certain events that have a certain totalisator pool associated with them through the rules of that pool. For example, a superquad pool may be associated with picking four placegetters in order in the last two races at a specified race meeting. If the participant has selected an event that is not one of the last two events at that particular meeting, the superquad pool would be excluded as an option for selection.

The method can include validating the quantum of the stake, including checking that the quantum is within prescribed limits, which may be set by the participant or wagering operator.

Limits set by the participant may be associated with what is referred to as Responsible Gambling, which helps to put ‘safe levels’ of betting outlay within the control of the participant.

Limits set by the wagering operator may be related to, but not limited to, accepting wagers that are appropriate to the size of the totalisator pools or appropriate to a processing capacity.

The method may include calculating the required break-down of the stake of the wager into component bets including determining the reward level that should be applied to the calculation. Preferably, there are multiple reward levels available to the participant, such as:
Level One—Bronze—This is the smallest reward level.
Level Two—Silver—This is the next smallest reward level.
Level Three—Gold—This is the next smallest reward level and may be the default reward level if no other level is selected.
Level Four—Platinum—This is the next smallest (or second highest) reward
Level Five—Diamond—This is the highest reward level.

If a reward level has been chosen, then an appropriate value will be associated with the reward level to be used in further calculations.

Once a reward level has been ascertained (either through selection or by default), that reward level is part of a parameter to determine the calculation of the underlying bets within the invention.

In accordance with another aspect of the invention, but not necessarily the broadest aspect, there is provided a method to create and transact wagers involving a participant and an organiser of wagering, the method including the following steps:
a) providing a plurality of choices of events having an outcome that can be wagered on, the event being nominated by the participant or assigned automatically;
b) providing a number of different betting types with predefined rules of winning with regard to each event;
c) receiving the participant's selected event, nominated selections in that event, a stake to be wagered and a selected or default reward level, the reward level providing a predefined allocation of a total stake across all betting types within the reward level; and
d) automatically determining an optimal allocation of the stake and nominated selections over one or more wagers to maximise the return if one or more of the selections receives a favourable result in the event that results in a return for the wager.

Preferably, the method includes, for each betting type, calculating a theoretical price of each permutation and the stake based on the nominated selection and market or assessed prices.

Suitably, the method includes providing an upper and lower boundary of the total outlay and individual bets, the upper and lower boundary applying minimum and maximum stakes respectively.

The method may include one or more additional tests, for example, ensuring the total outlay is well below a theoretical return.

The method may include checking the upper and lower boundary and external limits from the upper and lower boundary resulting in automatically recalculating the stake.

The method may include storing bet details including the bet type, permutation and stake amount.

Suitably, the step of automatically determining an optimal allocation includes the sub-steps of:

assessing the options of wagering;

assessing the odds of return for the options of wagering;

assessing the reward level for the options of wagering;

determining the optimal allocation dependent on the selected or default reward level;

recording bets against a customer account;

tracking the event; and

crediting of winning accounts.

According to another aspect of the invention, but not necessarily the broadest aspect, there is provided a computer implemented user interface to facilitate wagering and/or gaming for at least one event, the user interface comprising:

actuatable indicia to receive first inputs relating to at least one event, said first inputs including a stake, at least two selections in at least one event and at least one input relating to one or more bet types;

wherein a determination device in communication with the actuatable indicia executes computer readable program code components to automatically determine wagers according to the first inputs and determine a distribution of the stake between one or more bet types involving the at least two selections in proportion to a probability of bets making up the bet types yielding a return.

Further aspects and/or features of the present invention will become apparent from the following detailed description.

### BRIEF DESCRIPTION OF THE DRAWINGS

In order that the invention is more readily understood and may be put into practical effect, embodiments of the invention will be described by way of example only with reference to the accompanying drawings, wherein:

FIG. 1 is a general diagrammatic view of a system and apparatus to create and transact wagers with a betting organiser in accordance with embodiments of the invention;

FIGS. 2A to 2D are diagrammatic views illustrating methods of creating and transacting wagers with a betting organiser in accordance with embodiments of the invention with regard to four different types of users;

FIG. 3 is a schematic diagram of modules of a determination device of the system shown in FIG. 1;

FIG. 4 shows an example of a bet receipt showing details of wagers according to embodiments of the present invention;

FIG. 5 is a screenshot of a user interface for a wagering and/or gaming system illustrating the making of selections in an event;

FIG. 6 is a screenshot of the user interface illustrating the selection of a stake;

FIG. 7 is a screenshot of the user interface illustrating the selection of a reward level;

FIG. 8 is a screenshot of the user interface illustrating variation of the stake amount;

FIG. 9 is a screenshot of the user interface illustrating estimated returns;

FIG. 10 is a screenshot of the user interface illustrating confirmation of a wager;

FIG. 11 is a screenshot of the user interface illustrating ticket collection;

FIG. 12 is a screenshot of the user interface displaying a submitted wager;

FIG. 13 is a screenshot of the user interface illustrating a banker selection;

FIGS. 14 and 15 are screenshots of the user interface illustrating customisation of market prices;

FIGS. 16 and 17 are screenshots of the user interface illustrating customisation of reward levels; and

FIG. 18 is a screenshot of the user interface illustrating a profitability warning.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DESCRIPTION OF PREFERRED EMBODIMENTS

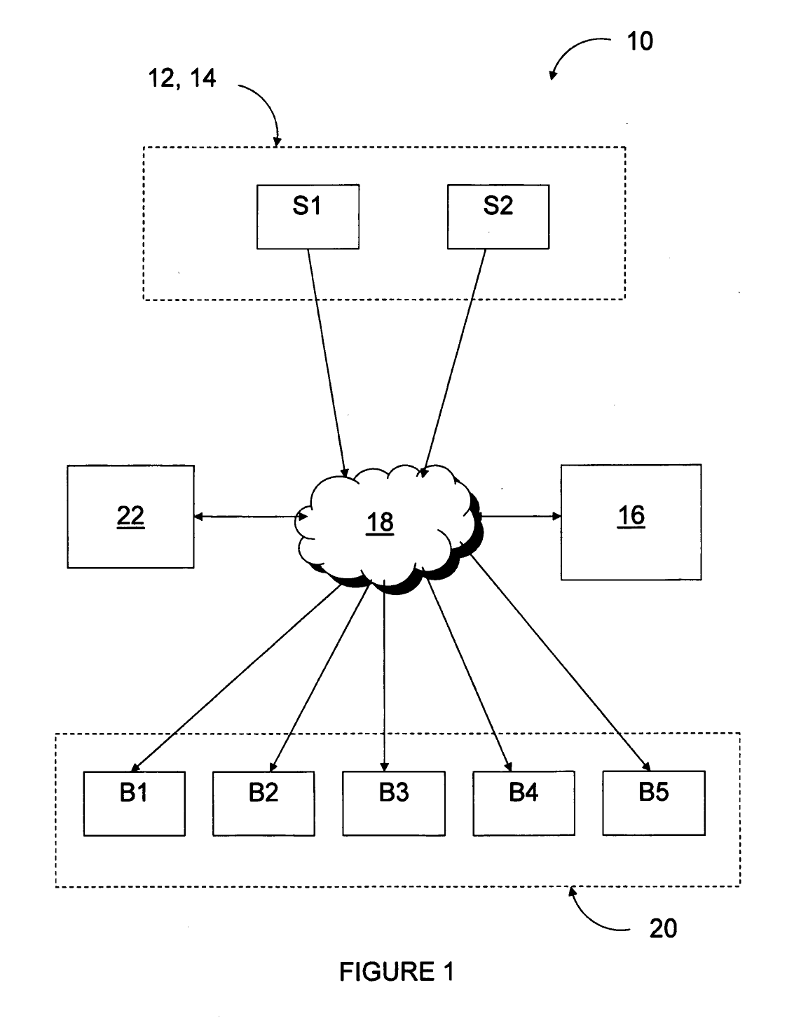

Referring to FIG. 1 there is shown a wagering and/or gaming system 10 to create and transact wagers with a betting organiser. System 10 can comprise a receiver 12 to receive first and second inputs S1 and S2 respectively. The first inputs S1 include a stake amount, such as $x and at least two selections in at least one event, such as at least two competitors or options in an event. First inputs can also include selection of one or more events, such as race y at location z, and at least one input relating to one or more bet types, such as a win, place, quinella, trifecta, quadrella etc. The at least one input relating to one or more bet types can be in the form of a reward level, as will be described in detail hereinafter. The second input S2 is related to one or more style criteria relevant to the selection or creation of wagers to be transacted, as discussed further below.

In some embodiments, system 10 includes receiver 12 in the form of a telecommunication access device 14 for receiving the first and second inputs S1 and S2 from a user. The telecommunication access device 14 is connectable to, or in some embodiments forms part of, a determination device 16. Determination device 16 can be a processor, such as a server accessible via a website or the like, and in some embodiments can receive inputs S1, S2 via a communications network 18, such as the Internet. Users can provide the first and/or second inputs to the telecommunication access device 14 via suitably enabled computing devices, such as smart phones, laptop or desktop computers, tablets or the like. In some embodiments, at least one of the first inputs S1 and/or at least one of the second inputs S2 is set by default or is selected by a user, as discussed further below with reference to examples.

Determination device 16 automatically determines options for transacting wagers according to the first and second inputs S1, S2, determines returns on determined options and selects the appropriate transacting wagers in accordance with the first and second inputs. Output device 20 is connectable to the determination device 16 to output one or more wagers, such as B1 to B5, which have been created to be transacted that fulfil the requirements of the first and second inputs. Output device 20 can be in the form of a display, such as a graphical user interface (GUI).

It can be seen from FIG. 1 that there is a transformation of the inputs S1 and S2 into actual wagers B1 . . . B5 by the determination device 16. One or more of wagers B1 . . . B5 can be selected and confirmed by a user or rejected.

In some embodiments, determining options of transacting wagers according to the first and second inputs entails communication with a market 22 providing wagers and returns on wagers to determine reward values on determined options. Determination device 16 automatically selects wagers in accordance with the first and second inputs and the one or more inputs relating to one or more bet types, such as reward levels, for the determined options based on the market communication.

The transformed selection B1 . . . B5 presented by the output device 20 allows the user to transact wagers and in a manner that best suits the user for transmission to a betting organiser on the market 22.

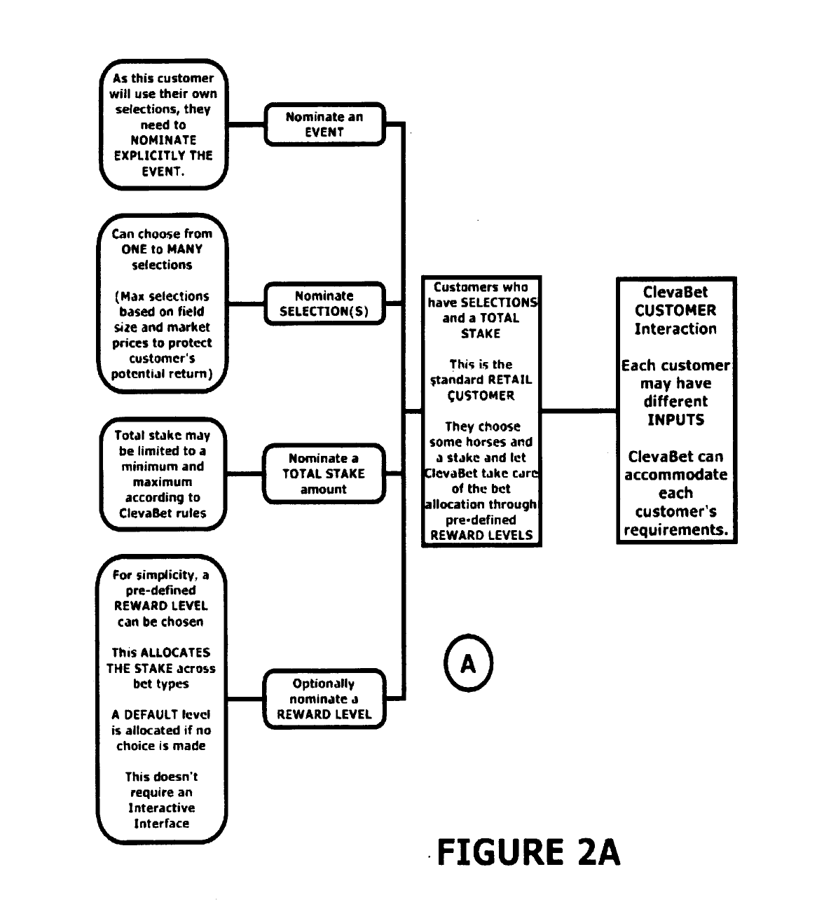

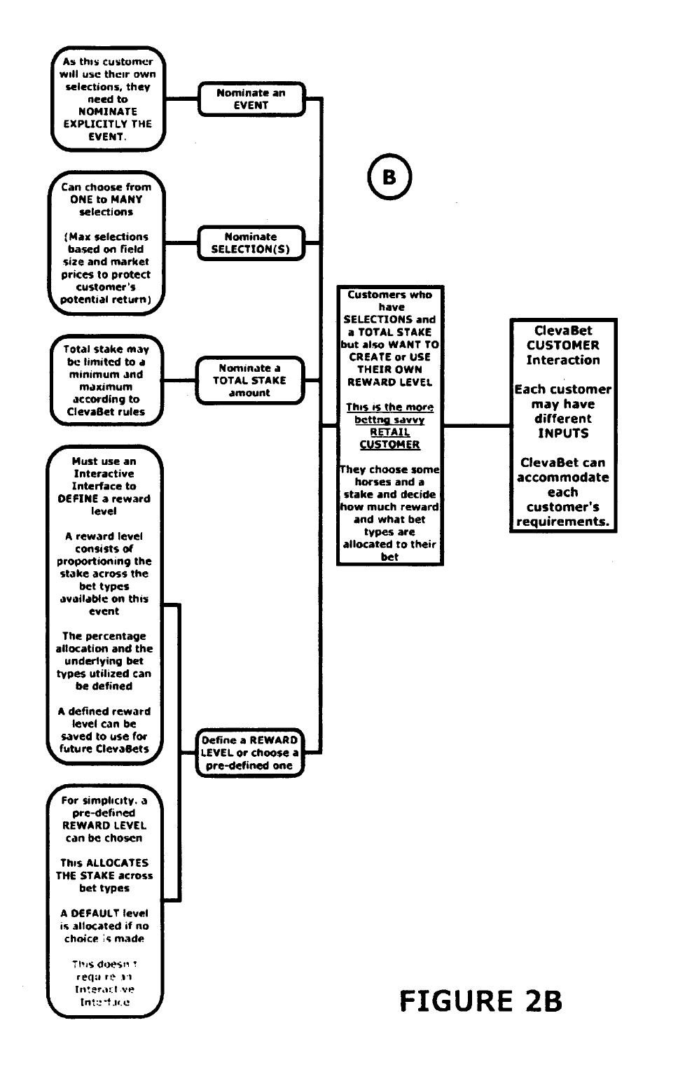

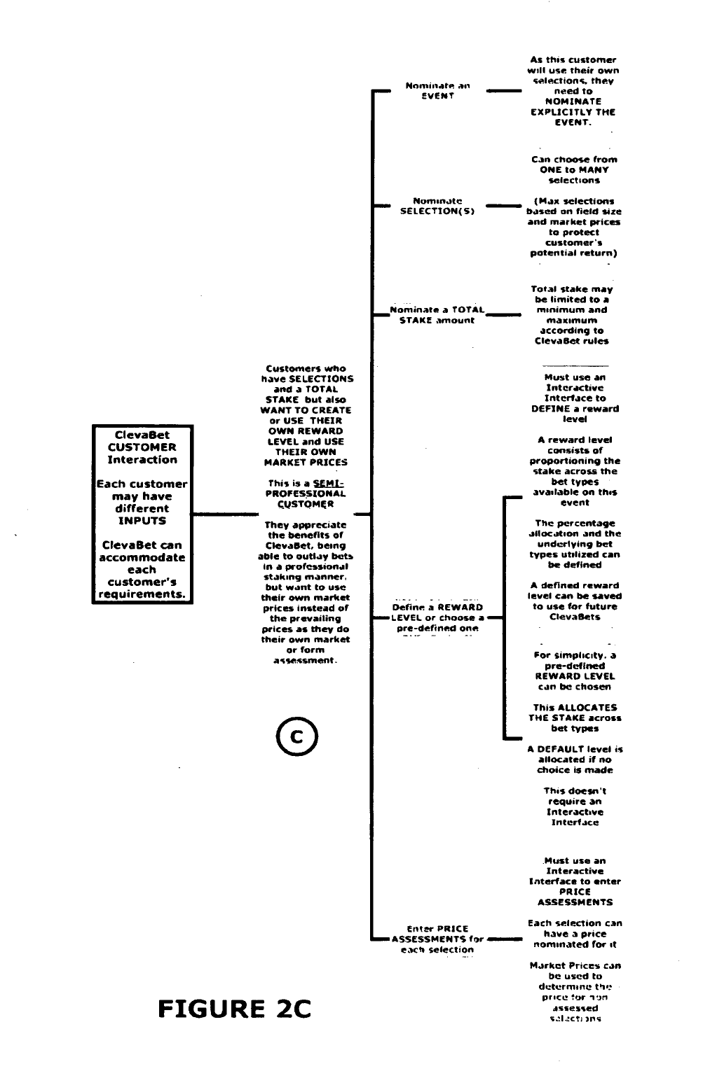

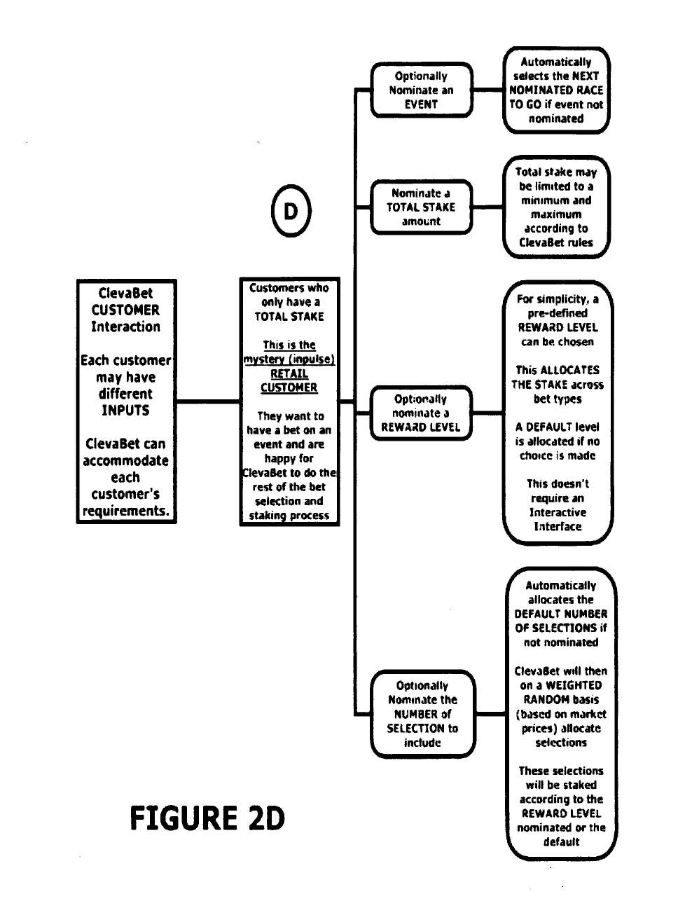

With reference to FIGS. 2A to 2D there are shown methods of use of the system 10 to create and transact wagers with a betting organiser in accordance with embodiments of the present invention with regard to four different types of users in creating a particular selected form of bet. In some instances, bets generated in accordance with embodiments of the present invention are referred to herein as a Clevabet™.

The four different types of users are exemplified by the different inputs by the customer to set the required wager. Usual retail customers are identified in FIG. 2A. More savvy or informed retail customers are identified in FIG. 2B. Mystery or impulse retail customers are identified in FIG. 2C. Semi-professional customers are identified in FIG. 2D. It will be appreciated that the labels ascribed to the four different types of users are provided by way of example only to illustrate four different categories of users.

The Clevabet is suitable for users who want to back more than one selection in race, such as multiple horses, but do not have the sufficient skill, time and/or opportunity to stake their bets in a professional manner. The Clevabet is designed to take the simple inputs that the user would already use, i.e.: total bet amount, or stake and the selection numbers, but stake these selections in a more professional manner instead of the haphazard manner typically employed.

The Clevabet will be available on all channels, such as in retail shops, at the races, over the telephone, online and most importantly, easily accessible via a mobile phone interface, such as via a smart phone, so that users who are most prone to inappropriate staking (i.e. those in retail shops and at the races) are easily able to place this type of bet.

According to some embodiments, by default, all ClevaBets would be placed at one or more “default” or mid-point risk levels. This means that there would be a balance between incorporating wagers in the win and the exotic pools. However, one variation is the ability for the user to change the risk profile of the bet. In one example, the user chooses an additional component. For simplicity, the variation options may just be a “high”, “medium”, or “low” risk choice. However, in other examples, more levels of risk can be provided, such as 5 levels of risk. The risk level will put more or less emphasis on a return from the exotic bets that make up the ClevaBet package.

Some examples of customer personas are as follows:

1. Colin the Casual Punter

2. Barry the Buzz Bettor

3. Vicki the Social Race Goer and

4. Nicholas the Metro Player.

Colin the casual punter is more likely to be a standard retail customer, who has made selections and a total bet as per FIG. 2A. This customer chooses some horses and a stake amount and lets ClevaBet take care of the bet allocation through pre-defined reward levels.

Barry the Buzz Bettor is likely to be a more betting savvy retail customer who wishes to make selections and decide a total stake, but also wants to create or use their own reward levels. For example, this customer chooses some horses and a stake and decides how much reward and what bet types are allocated to their bet. Their use of ClevaBet will follow the procedure as shown in FIG. 2B.

Nicholas the Metro Player can be the semi professional customer who has their own selections and decides a total stake, but also wants to create or use their own reward levels and use their own market prices. They appreciate the benefits of ClevaBet being able to outlay bets in a professional staking manner, but want to use their own market process instead of the prevailing prices because they do their own market or form assessment. This will therefore follow the procedure of FIG. 2C.

Vicki the Social Race Goer could be a customer requiring a mystery or impulse bet. The only decision they wish to make is the total stake. They want to have a bet on an event and are happy for ClevaBet to determine the rest of the bet selection and staking process. This can follow the process of FIG. 2D.

The proposed interface has been designed to ensure that the bet placement is as simple as possible and therefore overcoming difficulties typically encountered, for example, in placing a bet with an operator at the races.

The customer interaction steps for some embodiments would typically be:

1. Choose at least one event to bet on, such as race x at location y.

2. Choose the total amount of the stake to bet. It should be appreciated that a customer may have multiple bets in accordance with the present invention per event with different selections.

3. Choose the selections you want in the bet. In some embodiments, the minimum is one selection, which equates to a win bet. A maximum number of selections is theoretically limited by the size of the total stake amount, but in some embodiments could be about 8 selections.

4. Choose the risk/reward level. Alternatively, a default reward level of medium can be set, or a higher level or a lower level.

5. Press submit and a detailed breakdown of the bets is displayed.

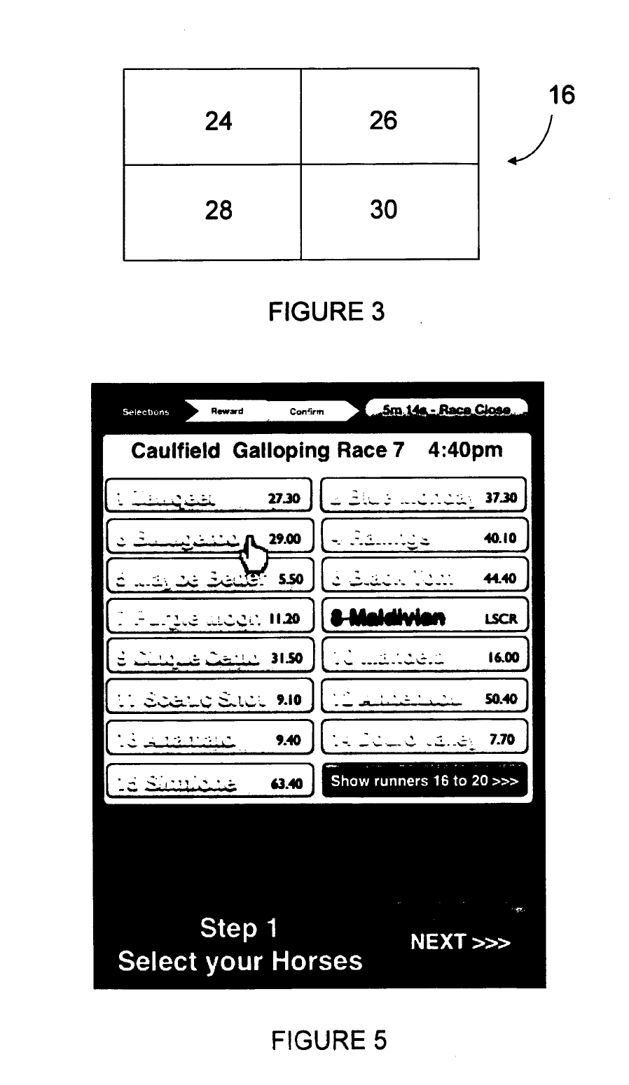

The internal processing by determination device 16 depends on the solution used to provide underwriting in the present invention. However, with reference to FIG. 3, according to some embodiments, determination device 16 can include an event control module 24, a bet acceptance module 26, a bet creation module 28 and a dividend declaration module 30.

The event control module 24 initializes the events upon which bets will be placed. The exotic bets types supported by each event are defined, e.g. a race with only 3 runners won't support a First4 bet type. The default risk level is assigned to each event. In many instances, the default risk level will not change.

However, there can be personal preferences where a customer prefers high risk with one type of betting, e.g. greyhound betting, and lower risk with another type of betting, e.g. galloping betting, as their default.

The bet acceptance module 26 will receive the selections for the wager, the total stake amount and the risk level and pass the parameters to the bet creation module 28. The bet acceptance module 26 will also perform normal validation tasks, such as checking that there are funds available to bet, the event is still open and other such validations. Other embodiments will also allow the ability to standout, rove and otherwise alter the weighting of the wager before it is submitted. This functionality is particularly application to online betting. The bet acceptance module 26 will also check that these parameters are valid.

The bet creation module 28 is responsible for taking the customer selections and placing them into the component win and exotic pools in the most staking efficient manner. This requires definition of the placement and algorithms behind the bet placement process.

The dividend declaration module 30 is responsible for dividend processing after bet placement, which includes calculating and providing a breakdown of the bet stakes and the percentage of the total stake on each bet type.

The user interface for the present invention is simple enough to use on a mobile phone screen, which can be a less refined version than the web based experience in view of data and display area constraints. The customer is provided with a clear idea of the amount of money (both absolute and percentage) of their entire stake that has been bet on each component bet type and the permutations covered. Since the permutations could be exhaustive, there is both a summary and detail screen.

On a website version of the user interface in particular, different reward levels can easily be determined and optionally colour coded, for example: bronze—silver—gold—platinum—diamond, to denote the different rewards levels in both colour and name in ascending order.

There are defined weightings between win/place and exotics across each different reward level.

The stake amount can be selected by the user up front. For convenience, some preset stake amounts are displayed, e.g. $10, $20, $50, $100. In some embodiments, there can be multiple stake amounts. For example, there can be two stake amounts. The first is for the win bets and the second is for the exotic bets.

The simplest mode is a single stake amount to cover both bet types, i.e. win bets and exotic bets. Here are some examples:
Total Stake is $50. $25 for the win bets and $25 for the exotic bets.
Total Stake is $100. $60 for the win bets and $40 for the exotic bets.
Total Stake is $100 which is spread over win/exotics according to a risk profile.

There is potential for the stake amount to have ‘odd’ cents left after the calculations are made for the exotic bets. This is undesirable so in preferred embodiments any left over amounts are absorbed into betting combinations for the win bets or other combinations according to the bets in the wager that have the highest probability of yielding a return.

Embodiments of the present invention include a number of bet staking rules. One rule is that the wager is always staked proportionally to the chance of the combination (win or exotic) winning. However, in some embodiments, there is an option for the customer to stake their selections at a fixed weighting if that is their preference.

Another rule is that the customer can dictate what proportion of their bet stake is placed on what are considered to be safer bets, such as win and place bets, versus what are considered to be riskier exotic bets, such as exacta and trifecta bets. The break-down of the bet allocation will depend on how many selections are chosen. TABLES 3 to 5 below shows some examples of pre-defined reward levels and the percentages or proportions of the stake associated with each bet type dependent on the reward level chosen:

### Percentage Allocation of Stake Based on 2 Selections Chosen

TABLE 3

| Level | Win | Place | Quinella | Exacta | Trifecta | First4 |
|---|---|---|---|---|---|---|
| Bronze | 50 | 50 | 0 | 0 | 0 | 0 |
| Silver | 50 | 25 | 0 | 25 | 0 | 0 |
| Gold | 35 | 15 | 0 | 50 | 0 | 0 |
| Platinum | 25 | 0 | 0 | 75 | 0 | 0 |
| Diamond | 0 | 0 | 0 | 100 | 0 | 0 |

### Percentage Allocation of Stake Based on 3 Selections Chosen

TABLE 4

| Level | Win | Place | Quinella | Exacta | Trifecta | First4 |
|---|---|---|---|---|---|---|
| Bronze | 50 | 50 | 0 | 0 | 0 | 0 |
| Silver | 50 | 25 | 0 | 17 | 8 | 0 |
| Gold | 35 | 15 | 0 | 33 | 17 | 0 |
| Platinum | 25 | 0 | 0 | 50 | 25 | 0 |
| Diamond | 0 | 0 | 0 | 50 | 50 | 0 |

### Percentage Allocation of Stake Based on 4+ Selections Chosen

TABLE 5

| Level | Win | Place | Quinella | Exacta | Trifecta | First4 |
|---|---|---|---|---|---|---|
| Bronze | 80 | 0 | 0 | 9 | 8 | 3 |
| Silver | 65 | 0 | 0 | 15 | 14 | 6 |
| Gold | 50 | 0 | 0 | 21 | 21 | 8 |
| Platinum | 35 | 0 | 0 | 27 | 26 | 12 |
| Diamond | 20 | 0 | 0 | 33 | 32 | 15 |

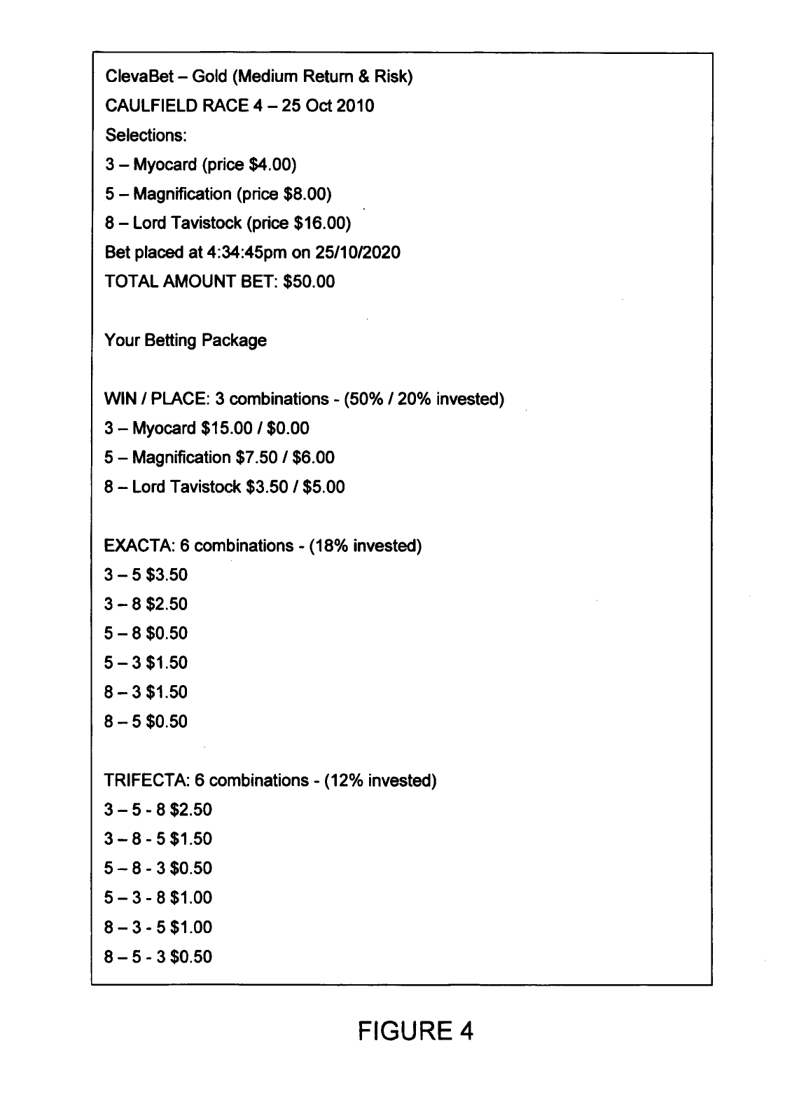

Once the bet has been submitted, the determination device 16 will create a bet receipt, as shown in FIG. 4. Certain known information will be detailed including the total amount staked, which will be the same as on the bet submitted and the amount bet on each combination,

Embodiments of the present invention include a method to create and transact wagers between a participant and an organiser of wagering. The method includes the step of providing a plurality of choices of events having an outcome that can be wagered on. The event is nominated by the user or assigned automatically.

The method includes providing a number of different betting types with predefined rules of winning with regard to each event.

The method includes receiving the participant's selected event, for example, a horse racing event, nominated selections in that event, a stake to be wagered and a reward level. The selection of a reward level provides the predefined allocation of a total stake across all betting types within a reward level. A default reward level is applied where a reward level is not nominated by the user.

The method includes the determination device 16 automatically determining an optimal allocation of the nominated selections over one or more wagers to maximise the return if one or more of those selections receives a favourable result in the event that results in a return for the wager.

According to some embodiments, the method includes, for each betting type, calculating the theoretical price of each permutation and the stake based on a nominated selection and market or assessed prices.

The method includes providing an upper and lower boundary of the total outlay and individual bets. The upper and lower boundary applies minimum and maximum stakes. The method includes conducting additional tests, for example, ensuring the total outlay is well below the theoretical return.

The method includes checking the upper and lower boundary and external limits from the upper and lower boundary resulting in an automatic recalculation of the stake. The method also includes storing bet details including the betting type, permutation and stake amount.

The step of automatically determining an optimal allocation includes assessing the options of wagering, assessing the odds of return for the options of wagering, assessing the reward level for the options of wagering determining the optimal allocation dependent on the particular selected or default reward level, recording bets against a customer's account, tracking the event and crediting winning accounts.

In some embodiments, the determination and selection of options for wagers occurs close to the beginning of the event upon which the wager is being transacted in order to determine an expected final reward value and allow the most accurate placement of derived wagers. In some embodiments, determination device 16 delays determining the exact wager on each bet within a bet type until such a time that the market is “well formed” and then place the bets. The customer will still know what percentage of their stake they have allocated on each bet type, but not the exact amount that is to be bet on each bet combination within the bet type.

Embodiments of the present invention will be further described with reference to the graphical user interface illustrated in the screenshots shown in FIGS. 5-18.

With reference to FIG. 5, the customer can make two or more selections in an event, e.g. horses in a horse race, if the product is in a standard configuration. The runners will be the basis for the selections in the underlying bet types that are provided by the product. The options for selections can include “market movers”, “other tipsters selections”, “the most other favoured runners in the market”, “weighted random selections”, etc.

Alternatively, the customer can make one selection, e.g. choose one runner and the system will provide the option for them to supplement the single selection with one or more additional selections. The options for the other selections can be provided automatically and can include the aforementioned “market movers”, “other tipsters selections”, “the most other favoured runners in the market”, “weighted random selections”, etc.

In some embodiments, bet types depend on multiple events. Selections in the multiple events can be selected by the customer or can be selected for the customer automatically according to default settings or can be a combination of customer selections and default selections. For example, the customer can input two or more selections in one event and selections in the remaining events comprise at least one selection from the customer and at least one default selection.

The user interface shown in FIG. 5 displays the location, type and time of the event and the time until the event commences. The current odds for each selection are shown adjacent to each selection. Once selections have been made, the next icon can be selected.

In a gaming implementation, the selections can be numbers, such as numbers in a game of roulette or any other selections required to provide inputs to the determination device 16 and the underlying bet types of the gaming system. In roulette and other gaming examples, the receiver 14 can be in the form of an area on a gaming table, such as a roulette table, for receiving the first inputs S1 and optionally one or more of the second inputs S2 from the user. Such embodiments can include a customer placing a bet via verbal commands to an operator working for the wagering operator. The gaming table or playing area can be an actual gaming table or playing area or an electronically implemented version.

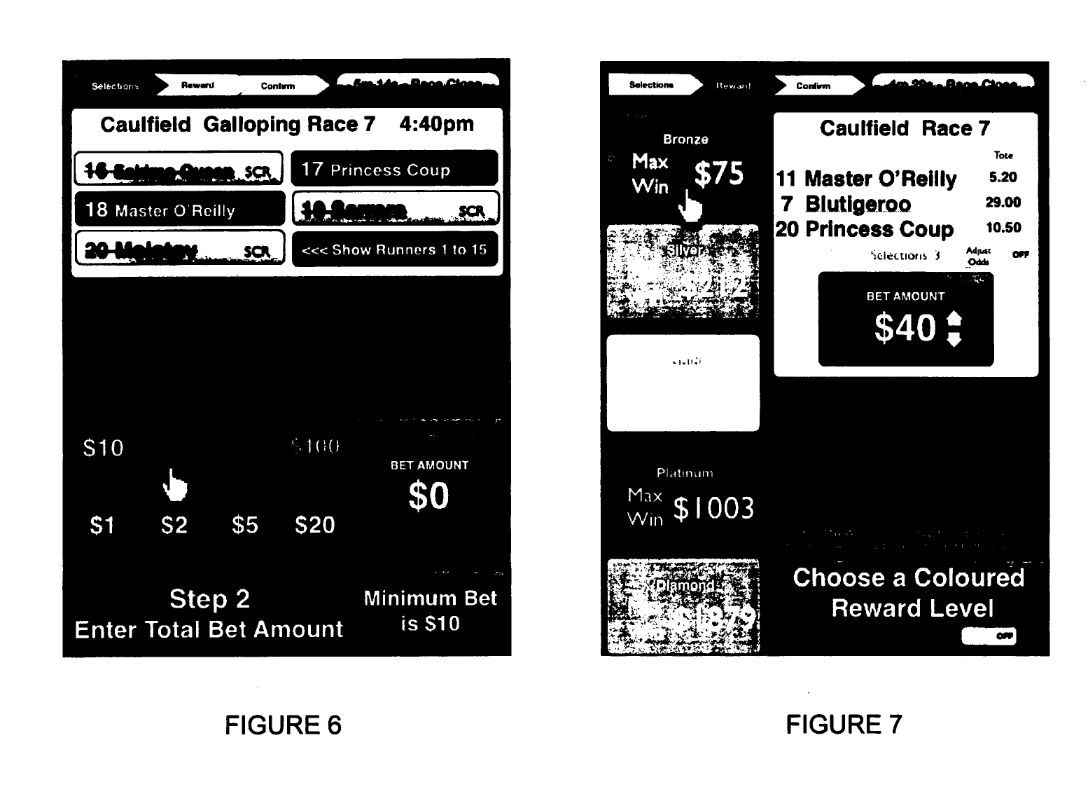

Referring to FIG. 6, the user interface displays the remaining selections (runners) for the event. The user interface also displays icons, the activation of which selects the respective amount of the stake to be wagered. In this example, eight different preset wager amounts are available for selection: $1, $2, $5, $10, $20, $25, $50 or $100. However, other preset amounts can be offered. Entering a total wager amount determines the total stake that will be bet on the selections across various underlying bet types making up the reward level described herein. User interface shows the total stake selected and in this example, a minimum stake for this event.

Referring to FIG. 7, as described above, embodiments of the invention can involve choosing a reward level that is appropriate to the risk/reward/confidence that the customer wants to invoke. Various characteristics of the user interface relating to the reward levels will now be described.

In some embodiments, the reward levels are coloured and the colour corresponds to the underlying value of the reward, e.g. diamond is worth more than gold and is coloured appropriately. In this example, the coloured reward levels in ascending order of the value of the possible return are bronze, silver, gold, platinum and diamond.

In some embodiments, an indication of the value of the possible return of each reward level is provided. In this example, an indicative “Max Win” value is displayed for each reward level. This is the maximum return the customer could receive for placing a wager according to a particular reward level if all of the requirements of the underlying bets are satisfied.

However, in other embodiments, a range (e.g. $200-$400) or a minimum (e.g. “$400+”) can be displayed for each reward level. Alternatively, another indicator of strength or ranking can be displayed so that the customer is aware that each reward level has an anticipated relative level of return if all of the requirements of the underlying bets based on the selections are satisfied. For example, with reference to FIG. 9, the user interface illustrates how the “Max Win” could alternatively be an “Estimated Win” with a minimum return rather than a precise amount.

In some embodiments, there can be one or more further reward levels, such as promotional rewards. For example, a branded reward level can exist comprising a promotional element to correspond with a certain event or promotion. This reward level can be additional to the standard reward levels and offer the customer additional or special value or prizes or returns based on the terms and conditions of the promotion.

In some embodiments of the present invention, another type of bet is a “quick” bet, which includes pre-defined betting configurations that restrict the bet types included in the determined options to one or more bet type across which the stake is allocated. For example, a “quick quinella” would only place the stake on the selections proportionally for a win and a quinella bet.

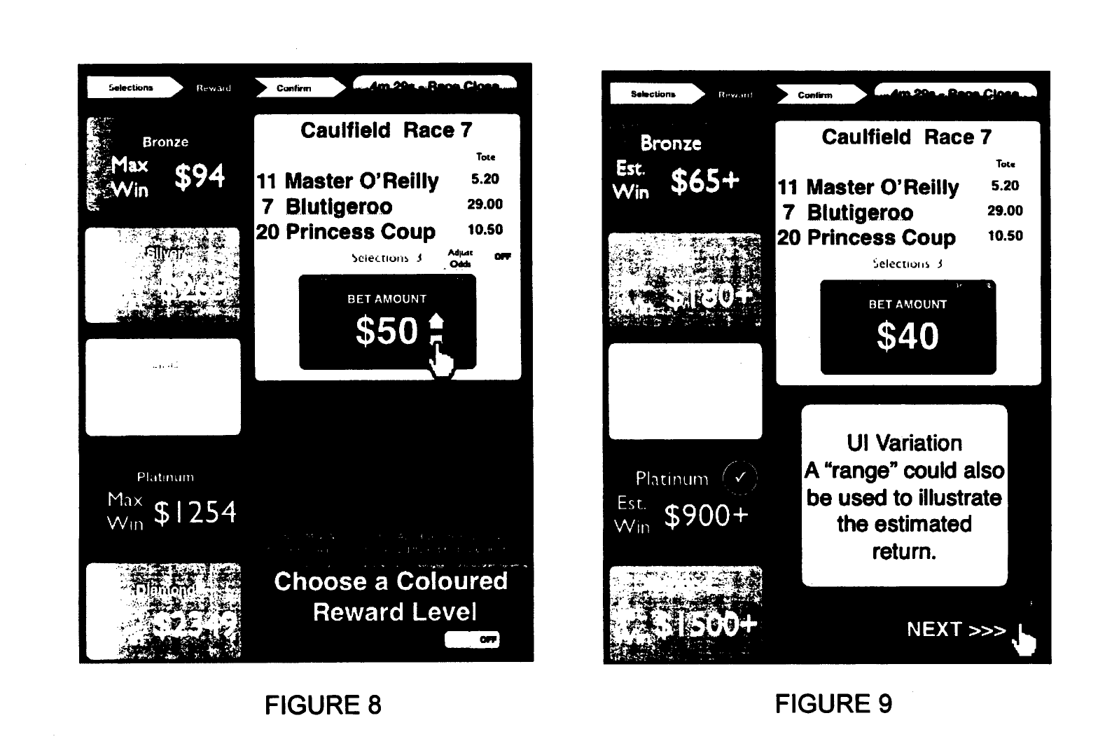

With reference to FIG. 8, the user interface can include options in the stake box to alter the total amount staked up or down. On-screen controls enable the stake to be increased or decreased, which will simultaneously update the indicated reward returns. In the example shown in FIG. 8, the stake has been increased to $50 from the $40 stake shown in FIG. 7. Consequently, the possible max win returns for each reward level have been updated. For example, by increasing the total stake from $40 to $50, the diamond reward level returns a maximum return of $2,349 instead of $1,879 if all of the requirements of the underlying bets based on the selections are satisfied.

In some embodiments, the user interface includes functionality that enables a customer to obtain a definition of the breakdown/rules of a reward level if the customer is unfamiliar with the underlying bets that make up that reward level. For example, hovering a cursor or the like over a reward level can display further details of the underlying rules and bets making up the reward level.

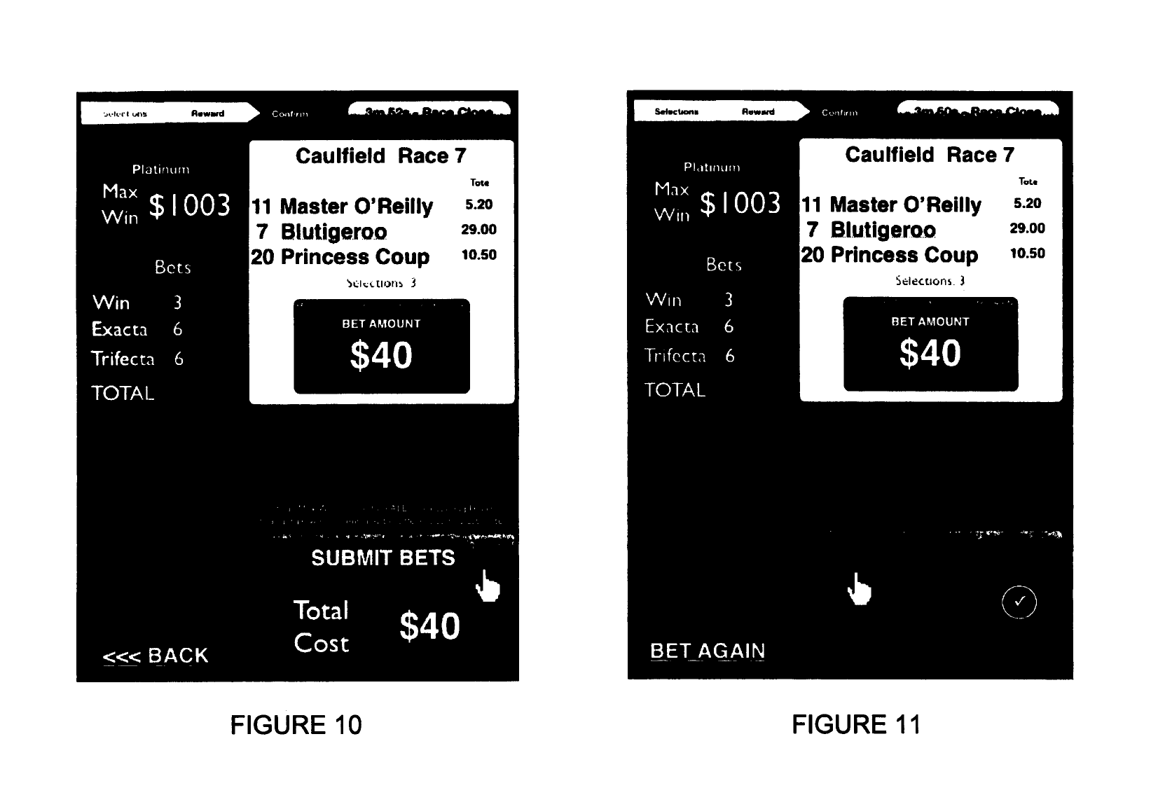

FIG. 10 shows a confirmation screen of the user interface. It shows the detail of the bet transaction that is going to take place. In this example, the customer has made three selections in a particular horse race for a total stake of $40. The reward level is platinum, which could have been a default reward level Or selected by the customer. This reward level has an estimated maximum return of $1,003 if all of the requirements of the underlying bets based on the selections are satisfied. For example, in a totalisator environment the actual returns are not known precisely until the event has closed and all wagers are collated. The underlying bets for this reward level includes three win bets, six exactas and six trifectas. The total stake of $40 is distributed between these three bet types with $14 on the win bets, $13 on the exactas and $13 on the trifectas. The user interface includes a submit bets icon to place the bets shown on the user interface.

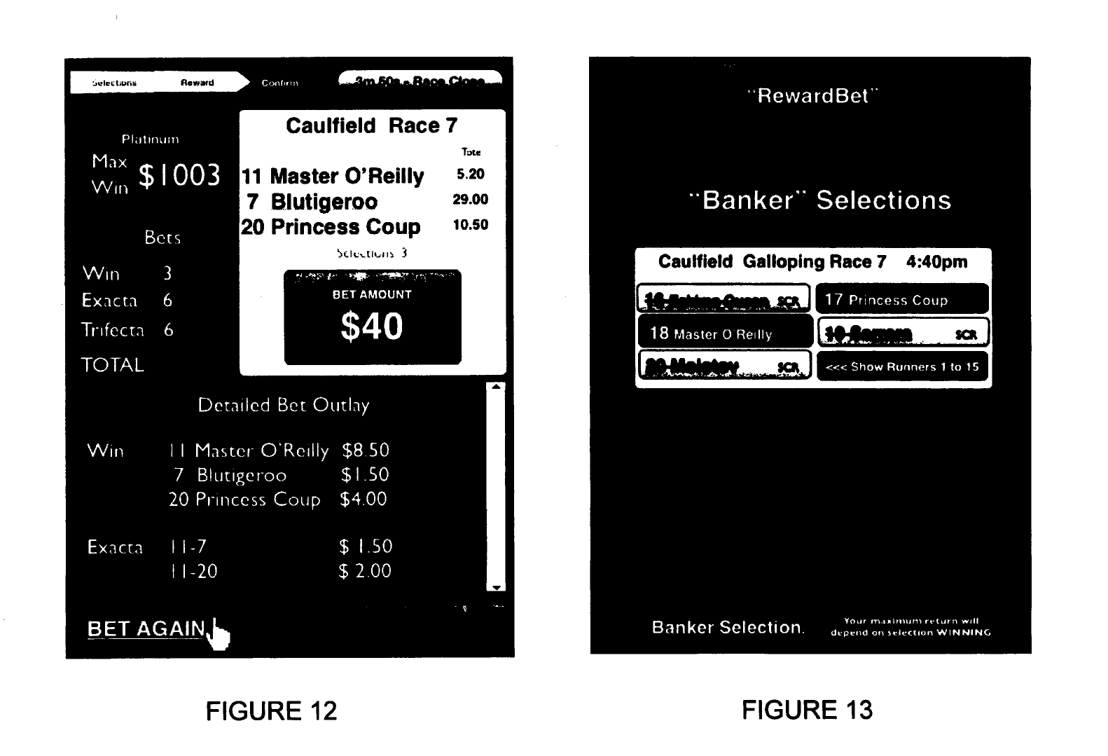

With reference to FIG. 11, once the bets have been submitted, the user interface can instruct the customer to collect a printed ticket, for example if the bet has been placed via a terminal at a retail outlet or race course. Alternatively, as shown in FIG. 12, the user interface displays a receipt for the submitted bets on the screen, which can be saved by the customer on their device and/or printed.

Referring now to FIG. 13, in some embodiments a customer can make one or more of their selections a “banker” selection. This will mean that the underlying bets will be skewed in their placement so that only those combinations that include the banker selection will be placed. Usually the banker selection will be for a win, but this can be altered under customisation functionality to apply to other place positions. The banker selections must fill their nominated place positions in the outcome of the event for there to be a return. However, since fewer combinations will be placed, the subsequent return will be greater than without using a banker selection since more of the total stake will be on these winning combinations. In the example shown in FIG. 13, the banker selection comprises two selections (horses) for a win. Another example of a banker selection can be having selections 2 and 5 as the banker selections for 1st and 2nd places in the event. This means that 2-5 or 5-2 will have to come 1st and 2nd respectively in the event and the other nominated selections will have to finish in the other places (assuming the bet type involves the selection of more than just the 1st and 2nd placegetters, as with bet types such as a trifecta or a first4 bet).

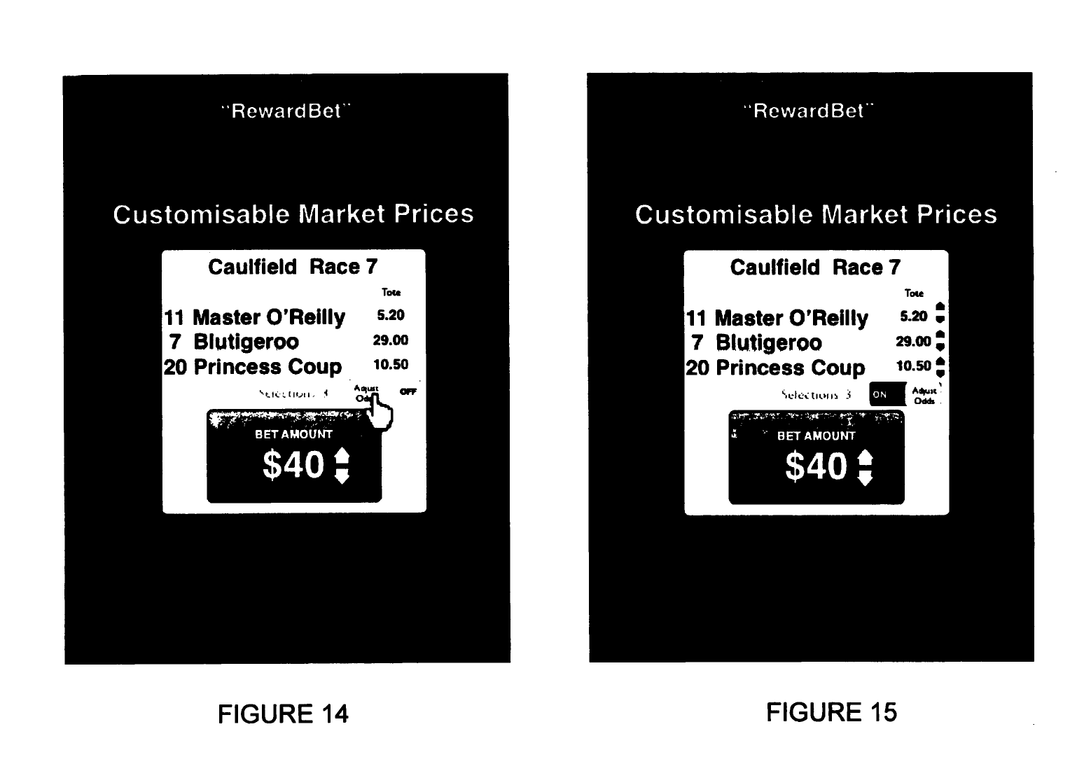

With reference to FIGS. 14 and 15, the user interface can include options on the market prices guide to alter the market prices, if applicable to the event that is being bet on. For example, this option may be provided for wagering on events such as horse races, but is unlikely to be used in gaming applications, such as roulette, which has fixed returns. FIGS. 14 and 15 illustrate how prices can be altered from those currently displayed on the screen, usually the prevailing market prices. This will allow customers to adjust for expected market condition changes and also to place selections based on their own market analysis.

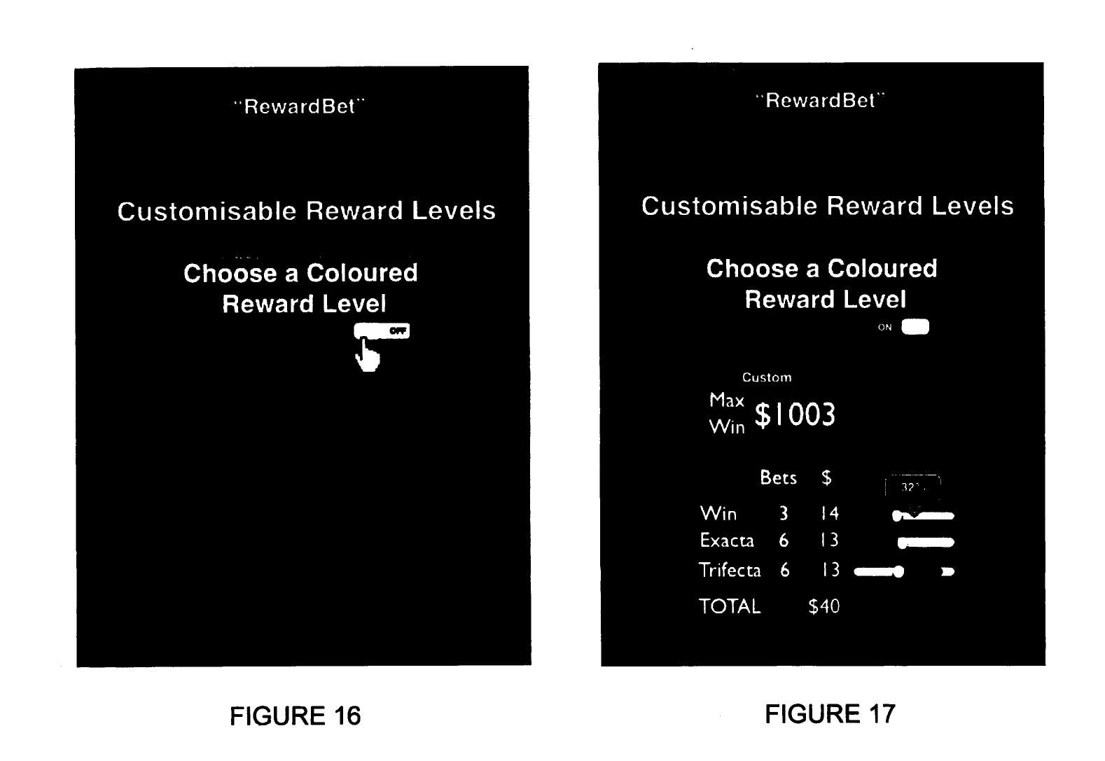

Referring to FIGS. 16 and 17, in some embodiments, the user interface displays icons and comprises underlying functionality to enable the customer to alter the constitution of the reward level to a customer's own requirement. This allows customers to define and alter the standard reward levels to suit their own requirements. The user interface shows the provision of screen devices, such as “slider bars”, to alter easily the various percentages of the stake distributed to each underlying bet type of each reward level, but other controls could be used. In some embodiments, the bet types constituting the reward level are variable by a user. For example, an exacta bet type could be exchanged for a different bet type in a particular reward level.

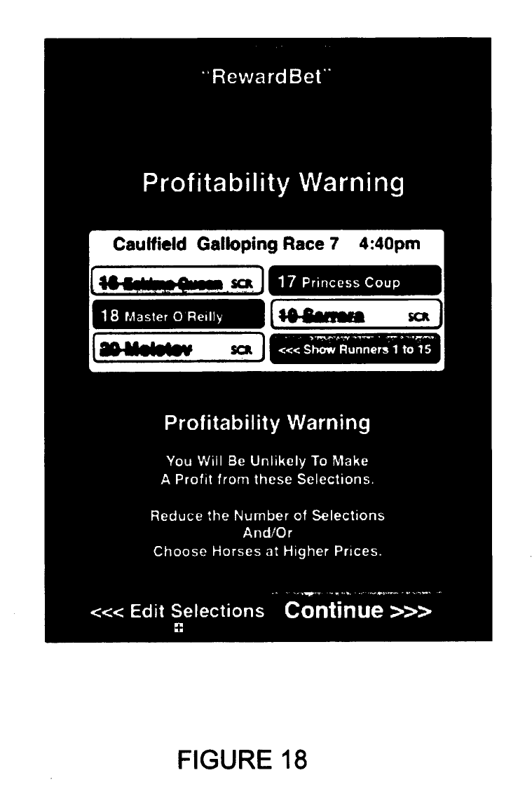

Referring to FIG. 18, embodiments of the present invention can include a profitability warning facility. It is an inbuilt safety mechanism which is not found in other gaming and wagering products. It supports responsible wagering by warning a customer when they are unlikely to make a profit from their wager. The profitability warning facility includes a warning that the customer has tried to bet on too many selections and/or too many selections at too low prices. In some embodiments, the profitability warning can be over-ridden such that the customer can proceed with the selected bets.

According to embodiments where a customer wishes to expend minimum effort in placing their bet, the customer can simply select the stake amount they wish to bet. The present invention will automatically determine the remaining required inputs, as for a mystery bet as shown in FIG. 2D. For example, the default event can be the next event at a particular location for which there is still time to place a bet. The default reward level can be the most conservative reward level or a middle reward level from the multiple reward levels available. The selections in the event can be the examples described herein, such as weighted random selections etc.

It will be appreciated that computer implemented versions of the present invention include at least one processor coupled to be in communication with a storage device in the form of a memory comprising a computer readable medium. The computer readable medium includes computer readable program code components at least some of which are executed by the processor to perform embodiments of the present invention described herein.

It will also be appreciated that the graphical user interface described herein comprises actuatable indicia selectable by the user, for example via a touch screen or using a moveable cursor and buttons, to receive and effect inputs which are processed by the at least one processor to perform embodiments of the present invention described herein.

Hence, embodiments of the present invention address or at least ameliorate the aforementioned problems of the prior art. The systems, methods and apparatus of the present invention enable a range of customers to use existing bet types in a new way. Inexperienced customers can take advantage of more complicated bet types and permutations without the need for extensive research or studying. Nonetheless, embodiments of the present invention are educational for customers by providing a breakdown of their underlying bets.

The reward levels of the present invention provide an informative, convenient and more efficient way to place bets and increase returns for both inexperienced and more experienced customers. Each wager includes a distribution of the stake between the one or more bet types involving at least two selections in proportion to a probability of bets making up the bet types yielding a return. Returns can be increased due to more efficient placement of the stake across different bet types according to the reward level rather than by merely increasing the stake. Features of the present invention such as customisable reward levels, customisable market prices and banker selections provide improved flexibility and versatility in the selection and placement of wagers.

Embodiments of the present invention encourage customers to partake in wagering and/or gaming when they otherwise would not due to a lack of understanding of bet types. Therefore, a greater amount of funds are in circulation within the system generally and in the exotic pools in particular. Betting can be evened out throughout a betting period, such as a day, thus providing greater stability by removing at least some of the volatility of dividends. Customers are provided with a more informed, enjoyable and exciting gaming experience and due to increased returns are typically able to play for longer. The profitability warning facility of the present invention encourages responsible gambling and informs customers when their selections are unlikely to return a profit, thus providing them with an opportunity to reconsider their selections.

Particular embodiments of systems, methods apparatus and user interfaces for wagering and gaming have been described herein including systems, methods apparatus and user interfaces to create and transact wagers with a betting organiser and in particular an online system. It is further envisaged that other embodiments of the invention could exhibit any number and combination of any one of the features previously described. However, it is to be understood that any variations and modifications can be made without departing from the scope of the present invention as defined by the attached claims.

In this specification, the terms “comprise”, “comprises”, “comprising” or similar terms are intended to mean a non-exclusive inclusion, such that a system, method or apparatus that comprises a list of elements does not include those elements solely, but may well include other elements not listed.

1. A wagering and/or gaming system for at least one event, the system comprising:
a receiver to receive first inputs relating to the event, said first inputs including a stake, at least two selections in at least one event and at least one input relating to one or more bet types; and
a determination device connectable to the receiver to automatically determine wagers according to the first inputs;
wherein the determined wager includes a distribution of the stake between the one or more bet types involving the at least two selections in proportion to a probability of bets making up the bet types yielding a return.

2. The system of claim 1, wherein the at least one input relating to one or more bet types is in the form of a reward level.

3. The system of claim 1, wherein the first inputs further include selection of one or more events.

4. The system of claim 1, wherein the receiver is in the form of a telecommunication access device for receiving inputs from a user over a communications network.

5. The system of claim 1, wherein the receiver receives at least one second input related to one or more style criteria relevant to the selection or creation of wagers to be transacted.

6. The system of claim 1, wherein the determination device is connectable to a market providing a market communication comprising wagers and returns on wagers to determine reward values on determined wagers.

7. The system of claim 5, wherein the determination device automatically determines wagers according to the first inputs and one of the following: the at least one second input; the market communication; the at least one second input and the market communication.

8. The system of any claim 1, wherein the system comprises an output device connectable to the determination device to output the selected wagers to be transacted.

9. The system of claim 1, wherein the system enables users to transact wagers that best suit the users for transmission to a betting organiser on the market.

10. The system of claim 5, wherein the one or more style criteria relevant to the selection and/or creation of wagers to be transacted includes one or more of the following: maximise a reward value; maximise a chance of a reward value; take a particular level of a conservative approach; take a particular level of a risky approach.

11. The system of claim 1, wherein the determination device includes one or more of the following for the determination of wagers: an event control module; a bet acceptance module; a bet creation module; a dividend declaration module.

12. The system of claim 1, wherein the receiver is in the form of an area on a gaming table for receiving inputs from the user.

13. The system of claim 1, wherein at least one of the first inputs and/or at least one of the second inputs is set by default or is selected by a user.

14. The system of claim 1, wherein the stake has one or more of the following characteristics: is specified by a user; is selected from one of a plurality of predetermined amounts; is variable by a user after selection; has a minimum amount for the event.

15. The system of claim 1, wherein an option for a selection in the event includes one or more of the following: a “market mover”; “other tipsters selections”; “the most other favoured selections in the market”; “weighted random selections”.

16. The system of claim 1, wherein the reward level comprises one or more of the following: a colour code according to a possible return value; a label according to a possible return value; a possible maximum win value; a possible minimum return value; an estimated possible return value; a range of possible return values; a promotional element; one or more special return values or prizes associated with promotion of one of the events.

17. The system of claim 1, wherein one or more of the following is variable by a user: the bet types constituting the reward level; the proportions of the stake distributed to the bet types of the reward level; a market price upon which a wager is based

18. The system of claim 1, wherein a selection in the event can include a banker selection which must fill a position nominated in the bet type in an outcome of the event for the wager to be successful.

19. The system of claim 1, further including the determination device generating a profitability warning when it is unlikely that a profit will be made from the wager.

20. A method of wagering and/or gaming for an event including the following steps:
a receiver receiving first inputs relating to the event, said first inputs including a stake, at least two selections in the event and at least one input relating to one or more bet types;
automatically determining wagers according to the first inputs in a determination device connectable to the receiver; and
determining a distribution of the stake between one or more bet types involving the at least two selections in proportion to a probability of bets making up the bet types yielding a return.

21. The method of claim 20, wherein the at least one input relating to one or more bet types is in the form of a reward level.

22. The method of claim 20 including the receiver receiving at least one second input related to one or more style criteria relevant to the selection or creation of wagers to be transacted.

23. The method of claim 20, including the receiver receiving at least one second input related to one or more style criteria relevant to the selection or creation of wagers to be transacted.

24. The method of claim 20, including a market, connectable to the determination device, providing a market communication comprising wagers and returns on wagers to determine reward values on determined wagers.

25. The method of claim 23, including the determination device automatically determining wagers according the first inputs and one of the following: the at least one second input; the market communication; the at least one second input and the market communication.

26. The method of claim 20, including outputting selected or created wagers to be transacted to an output device connectable to the determination device and/or to a betting organiser.

27. The method of claim 20, including setting at least one of the first inputs and/or at least one of the second inputs by default or in response to a user input.

28. The method of claim 20, including varying one or more of the following in response to a user input: the bet types constituting the reward level; proportions of the stake distributed to the bet types of the reward level; a market price upon which a wager is based

29. The method of claim 20, including specifying one or more selections of a banker selection for the event in each bet type.

30. The method of claim 20, including the determination device generating a profitability warning when it is unlikely that a profit will be made from the wager.

31. An apparatus to facilitate wagering and/or gaming for at least one event, the apparatus comprising:
a receiver to receive first inputs relating to at least one event, said first inputs including a stake, at least two selections in the event and at least one input relating to one or more bet types; and
a determination device connectable to the receiver to execute computer readable program code components to automatically determine wagers according to the first inputs and to determine a distribution of the stake between one or more bet types involving the at least two selections in proportion to a probability of bets making up the bet types yielding a return.

32. A computer implemented user interface to facilitate wagering and/or gaming for an event, the user interface comprising:
actuatable indicia to receive first inputs relating to the event, said first inputs including a stake, at least two selections in the event and at least one input relating to one or more bet types;
wherein a determination device in communication with the actuatable indicia executes computer readable program code components to automatically determine wagers according to the first inputs and determine a distribution of the stake between one or more bet types involving the at least two selections in proportion to a probability of bets making up the bet types yielding a return.
